(19) United States
(12) Patent Application Publication
(10) Pub. No.: US 2026/0178183 A1
(43) Pub. Date: Jun. 25, 2026

(54) INFORMATION PROCESSING DEVICE AND INFORMATION PROCESSING METHOD

(71) Applicant: Faurecia Clarion Electronics Co., Ltd., Saitama-shi (JP)

(72) Inventor: Takuma SHIOGUCHI, Saitama (JP)

(21) Appl. No.: 19/420,942

(22) Filed: Dec. 16, 2025

(30) Foreign Application Priority Data
Dec. 19, 2024 (JP) 2024-224400

(51) Int. Cl. G06F 3/0486; G06F 3/14; G06F 3/04845

(52) U.S. Cl. CPC G06F 3/0486; G06F 3/1431; G06F 3/04845

(57) ABSTRACT

An information processing device that can be connected to a source device to communicate. The information processing device includes a display part having a first screen, a display control unit that displays an image on the first screen, and an acquisition unit that acquires a shared source image, which is a display image on a second screen of the source device. The display control unit detects a prescribed first operation, displays a first window, and displays a shared source image acquired by the acquisition unit in the first window, and when a prescribed second operation for a first object displayed on the first screen is detected, instructs the source device to display a second window and to display the first object in the second window.

### TECHNICAL FIELD

The present disclosure generally relates to an information processing device and an information processing method.

### BACKGROUND

A technology is known for mirroring display screens (that is, images displayed on the screen). For example, Patent Document 1 (U.S. Patent No. 9652193) describes a specific configuration of a system to which this type of technology is applied. In Patent Document 1, for example, the display screen of a source device can be displayed on a sync device by mirroring.

However, in Patent Document 1, for example, objects cannot be added to the screen of the source device from the sync device, which leaves room for improvement in terms of usability.

In light of the circumstances described above, an object of the present disclosure is to provide an information processing device and an information processing method that can improve the usability on the sync device side.

### SUMMARY

According to an embodiment of the present disclosure, the information processing device is a device that can be connected to a source device to communicate. The information processing device includes a display part having a first screen, a display control unit that displays an image on the first screen, and an acquisition unit that acquires a shared source image, which is a display image on a second screen of the source device. The display control unit detects a prescribed first operation, displays a first window, and displays a shared source image acquired by the acquisition unit in the first window, and when a prescribed second operation for a first object displayed on the first screen is detected, instructs the source device to display a second window and to display the first object in the second window.

According to an embodiment of the present disclosure, an information processing device and an information processing method that can improve the usability on the sync device side are provided.

### DRAWINGS

FIG. 1 is a diagram schematically depicting a vehicle in which an in-vehicle system is installed according to an embodiment of the present disclosure;

FIG. 2 is a block diagram depicting a configuration of an information processing device according to an embodiment of the present disclosure;

FIG. 3 is a diagram depicting an example of a display screen displayed on a screen of a display part of an information processing device according to an embodiment of the present disclosure;

FIG. 4 is a diagram depicting an example of a display screen displayed on a screen of a display part of an information processing device according to an embodiment of the present disclosure;

FIG. 5 is a diagram depicting an example of a display screen displayed on a screen of a display part of an information processing device according to an embodiment of the present disclosure;

FIG. 6 is a diagram depicting an example of a display screen displayed on a screen of a display part of an information processing device according to an embodiment of the present disclosure;

FIG. 7 is a diagram depicting an example of a display screen displayed on a screen of a display part of an information processing device according to an embodiment of the present disclosure;

FIG. 8 is a flowchart depicting a process executed by a control unit of an information processing device according to an embodiment of the present disclosure;

FIG. 9 is a flowchart depicting a process executed by a control unit of an information processing device according to an embodiment of the present disclosure;

FIG. 10 is a diagram depicting an example of a display screen displayed on a screen of a display part of an information processing device according to an embodiment of the present disclosure;

FIG. 11 is a diagram depicting an example of a display screen displayed on a screen of a display part of an information processing device according to Modified Example 1 of the present disclosure; and

FIG. 12 is a diagram depicting an example of a display screen displayed on a screen of a display part of an information processing device according to Modified Example 2 of the present disclosure.

### DETAILED DESCRIPTION OF EMBODIMENTS

The following description relates to an information processing device and an information processing method according to an embodiment of the present disclosure. Common or corresponding elements are marked with the same or similar reference codes, and duplicate descriptions are simplified or omitted as appropriate.

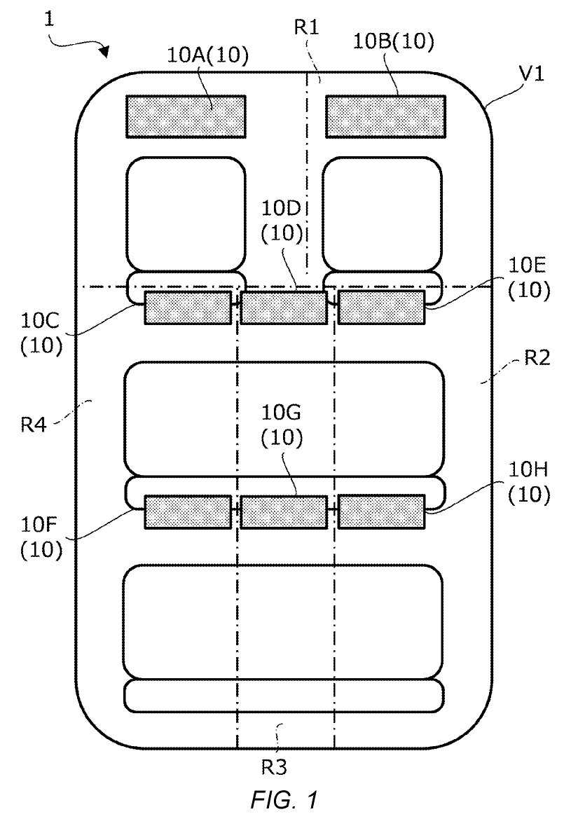

FIG. 1 is a diagram schematically depicting a vehicle V1 in which is installed an in-vehicle system 1 according to an embodiment of the present disclosure. The vehicle V1 is an eight-person standard passenger car and is an example of a moving body. The interior of the vehicle has three rows of seats. The first row seats are the driver's seat and passenger seat. The second row and third row seats are bench seats that can seat three people.

The seat layout in the vehicle is not limited to that depicted in FIG. 1. For example, four or more rows of seats may be installed in the vehicle interior. The bench seat may be one on which four or more people can sit. The vehicle V1 is not limited to a regular passenger car, but may also be a large vehicle such as a bus. The vehicle V1 may be replaced by another moving body such as an airplane.

The in-vehicle system 1 includes a plurality of information processing devices 10. The information processing device 10 is an in-vehicle device capable of displaying various objects, and is an example of a computer. For example, eight information processing devices 10 are installed in the vehicle interior. The information processing device 10 installed in the left seat of the first row (for example, the driver's seat) is referred to as "information processing device 10A". The information processing device 10 installed in the right seat of the first row (for example, the passenger seat) is referred to as "information processing device 10B". The three information processing devices 10 installed for the second-row bench seats are referred to as "information processing device 10C", "information processing device 10D", and "information processing device 10E", respectively, from the left seat side. The three information processing devices 10 installed for the bench seat in the third row are denoted as "information processing device 10F", "information processing device 10G", and "information processing device 10H", respectively, from the left seat side.

The installation number and installation position of the information processing devices 10 are not limited to those indicated in FIG. 1. For example, some seats may not have an information processing device 10 installed, or some seats may have two or more information processing devices installed.

The information processing device 10 is not limited to an in-vehicle device. The information processing device 10 may be a portable device such as a smartphone, a tablet terminal, or a notebook PC (Personal Computer). For example, the information processing device 10A may be an in-vehicle device, and the other information processing devices 10B to 10H may be smartphones or tablet terminals. In other words, the information processing devices 10A to 10H may be different types of devices.

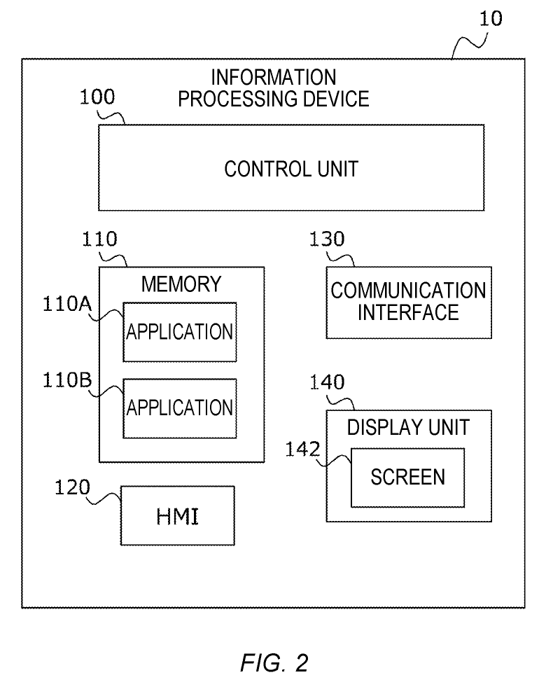

FIG. 2 is a block diagram depicting a configuration of an information processing device 10 according to an embodiment of the present disclosure. As depicted in FIG. 2, the information processing device 10 includes a control unit 100, a memory 110, an HMI (Human Machine Interface) 120, a communication interface 130, and a display part 140. The information processing device 10 may include other configurations not depicted in FIG. 2. In other words, there is a degree of freedom in the form of the information processing device 10, and various design changes are possible.

The control unit 100 is configured, for example, as a large scale integration (LSI), and is provided with a central processing unit (CPU), a random-access memory (RAM), a read-only memory (ROM), and a digital signal processor (DSP). The control unit 100 may be called, for example, a processor, a microprocessor unit (MPU), or a microcontrol unit (MCU).

The control unit 100 controls the information processing device 10 by reading various programs and data stored in a built-in ROM or in the memory 110, and using a RAM as a work area.

The memory 110 is, for example, an auxiliary storage device such as a hard disk drive (HDD) or a solid-state drive (SSD), or a non-volatile semiconductor memory such as a flash memory, an erasable programmable read-only memory (EPROM), or an electrically erasable programmable read-only memory (EEPROM).

The memory 110 stores, for example, an application 110A, which is an example of a program. The control unit 100 executes the application 110A, thereby executing various processes (for example, processing of various images) according to an embodiment of the present disclosure. By executing the application 110A, each of the information processing devices 10A to 10H can operate, for example, as a source device that is the source of mirroring (in other words, the source from which images are shared), and can also operate as a sync device that is the destination of mirroring (in other words, the destination to which images are shared).

An application 110B is, for example, an application for streaming video and an application for displaying a navigation screen. Although two applications 110A and 100B are depicted in FIG. 2, the information processing device 10 may store more applications. The memory 110 of the information processing devices 10A to 10H may respectively store different applications.

The HMI 120 (Human Machine Interface) may be any of various user interfaces, such as hardware, software, or a combination of these. By way of example, the HMI 120 includes mechanical operators such as mechanical switches, buttons, knobs, and wheels of types including mechanical type, capacitive non-contact systems, and membrane type; a GUI (Graphical User Interface) provided in a touch-panel environment; and a remote controller. The HMI 120 may include an interface that performs gesture recognition, voice recognition, and the like.

The communication interface 130 is an interface that connects the information processing device 10 to various external devices so that they can communicate with each other using wireless communication standards such as Wi-Fi, Wi-Fi Direct (registered trademark), and Bluetooth (registered trademark). The information processing devices 10A to 10H are connected to each other via a communication interface 130 so as to be able to communicate with each other, and are also connected to servers, clouds, and the like installed on an external network so as to be able to communicate with each other.

A part of the various processes according to an embodiment of the present disclosure may be executed by, for example, an external device connected to the information processing device 10 via the communication interface 130 instead of the control unit 100.

The display part 140 includes a screen 142 configured with, for example, an LCD (Liquid Crystal Display) panel, an organic EL (Electro Luminescence) panel, an LED (Light-Emitting Diode) panel, or the like. The screen 142 is equipped with a touch panel.

The user can perform various touch operations on the display, such as touch-on (touching the screen 142 with a finger), touch-off (removing a finger from the screen 142), flick (swiping a finger across the screen 142), swipe (slide), drag, and drop. The control unit 100 detects the coordinates on the screen 142 that are touch operated, and executes a process associated with the detected coordinates.

When describing the structural element of a specific information processing device 10 among the information processing devices 10A to 10H, the corresponding alphabet will be added at the end. For example, the display part 140 and screen 142 of the information processing device 10A are referred to as "display part 140A" and "screen 142A", respectively.

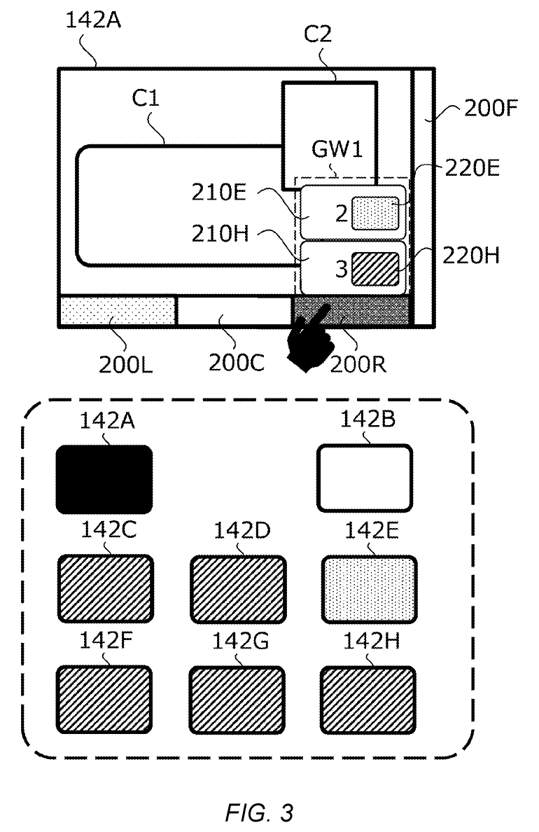

The upper diagrams in FIG. 3 to FIG. 5 show examples of display screens displayed on the screen 142A of the information processing device 10A. The hand depicted in each diagram depicting an example of a display screen indicates the hand of a user performing a touch operation. The hatched arrows indicate the movement of the user's hand performing the touch operation. The lower diagrams in FIG. 3 to FIG. 5 are diagrams simply depicting the installation positions of the information processing devices 10A to 10H (screens 142A to 142H) in the vehicle interior. In the lower diagrams, differences in the display contents of the screen 142 of each information processing device 10 are expressed by differences in the color and hatching of each block.

In the example described below, the information processing device 10A operates as a sync device, and the information processing devices 10B to 10H operate as source devices. In other words, the display part 140A of information processing device 10A is an example of a display part having a first screen. A control unit 100A of the information processing device 10A is an example of a display control unit that displays an image on the first screen. The information processing device 10 to be operated as a sync device or a source device can be appropriately set by a user operation.

It should be noted that, as used in the present disclosure, any reference to an element using a designation such as "first", "second", or the like does not generally limit the quantity or order of those elements. These designations are used for convenience to distinguish between two or more elements. Thus, a reference to first and second elements does not mean, for example, that only two elements are employed or that the first element must precede the second element.

In the example of FIG. 3, objects C1 and C2 are displayed on screen 142A. An object is a representation of the information that an application has executed. The object may be a symbol of such information, an object indicating the type of application, or the like. The shape of the object displayed on the screen 142 is, for example, a rectangle. For example, the user can change the display size of an object by touching and swiping a corner of the object.

The objects may include, for example, video content, navigation content that displays information related to navigation functions, parking assistance content that displays an overhead image of the vehicle when parking, audio player content for operating audio functions, radio operation content for selecting radio stations, vehicle interior control content for adjusting the temperature and airflow of the air conditioner installed in the vehicle, and vehicle-related content for displaying and setting various information related to the vehicle (for example, speedometer, tachometer).

For example, an example of screen operation in the in-vehicle system 1 will be described assuming a situation in which a parent sits in the driver's seat and children (child users) sit in the other seats. For convenience, the parent sitting in the driver's seat will be referred to as "Parent User A".

For example, parent user A and the child user can individually enjoy content on the information processing devices 10 installed at their respective seats. There are cases where parent user A wants to know what content the child user is viewing. However, for a parent user A seated in the driver’s seat, directly visually recognizing the screen 142 of the information processing device 10 of another seat is difficult. Therefore, in the present embodiment, parent user A can view the display contents of the screen 142 of the information processing device 10 at the other seat through the screen 142A of the information processing device 10A.

In addition, for a child user who is unfamiliar with operation of the information processing device 10, for example, performing operations such as newly selecting and playing back content or changing a layout of objects displayed on the screen 142 is difficult. Parent user A cannot physically reach the screen 142 of the child user's information processing device 10. Accordingly, for the parent user A, directly touching and operating the screen 142 of the child user’s information processing device 10 is also difficult. Therefore, in the present embodiment, the parent user A is configured to be able to remotely operate the information processing device 10 of the child user via the information processing device 10A.

The first selection operation, which is a trigger for checking the displayed content and performing remote operation, is illustrated in FIG. 3. In the example depicted in FIG. 3, parent user A touches right-side region 200R near the bottom edge of the screen with their finger and swipes vertically upward for a prescribed distance or more. As a result, for example, the group window GW1 appears as though being pulled out vertically upward from a lower end of the screen. In the present embodiment, the frame of the group window GW1 is not displayed on the screen. In another embodiment, the frame of the group window GW1 may be displayed on the screen.

The first selection operation prescribed is an operation for selecting a partitioned region from a prescribed space. The regions R1 to R4 depicted in FIG. 1 are examples of partitioned regions partitioned from the vehicle interior, which is an example of a prescribed space. Region R1 includes the passenger seat. Region R2 includes the right row of rear seats (the second row right seat and the third row right seat). Region R3 includes the center row of rear seats (the center seat of the second row and the center seat of the third row). Region R4 includes the left row of rear seats (the left seat in the second row and the left seat in the third row).

The first selection operation indicated in FIG. 3 is an operation for selecting the region R2. The first selection operation is not limited to this operation (in other words, an operation of swiping a finger vertically upward a prescribed distance within the right-side region 200R). The first selection operation may be an operation of selecting region R1 (in other words, an operation of swiping a finger horizontally to the left a prescribed distance within right edge region 200F near the right edge of the screen). The first selection operation may be an operation of selecting region R3 (in other words, an operation of swiping a finger vertically upward a prescribed distance within central region 200C near the bottom edge of the screen). The first selection operation may also be an operation of selecting the region R4 (in other words, an operation of swiping a finger vertically upward by a prescribed distance within the left-side region 200L near the lower end of the screen).

FIG. 3 to FIG. 6, for convenience, the right-side region 200R, the central region 200C, the left-side region 200L, and the right edge region 200F are depicted, but these regions are not elements displayed on the screen. In another embodiment, these regions may be displayed on the screen.

The group window GW1 is associated with the right row of rear seats (in other words, the region R2). The group window GW1 displays components 210E and 210H corresponding to the information processing devices 10E and 10H installed in the right row of rear seats. The components in the group window are collectively referred to as "components 210". Components 210E displays column information (for example, "2" indicating the second column) and a small window 220E. Component 210H displays column information (for example, "3" indicating the third column) and a small window 220H. The small windows within the component 210 are collectively referred to as "small windows 220".

In the small window 220, the display screen of the corresponding information processing device 10 is displayed in, for example, MIRACAST (registered trademark). Specifically, the display screen of the information processing device 10E (that is, a mirrored image of the sharing source screen 142E) is displayed in the small window 220E. The small window 220H displays the display screen of the information processing device 10H (in other words, a mirrored image of the sharing source screen 142H). In another embodiment, the display screen (mirrored image) of the share source information processing device 10 may be displayed in the small window 220 (and window W1 described later) using another method such as Android (registered trademark) Auto or CarPlay (registered trademark).

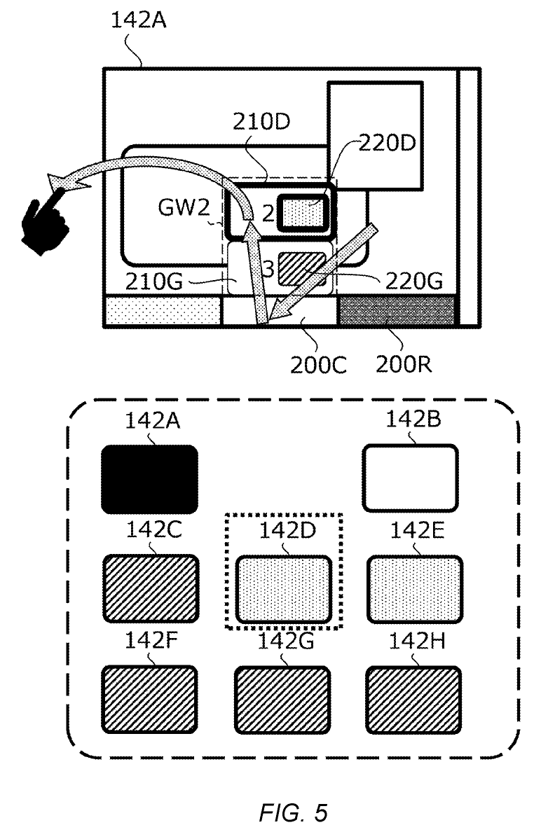

When the first selection operation is performed on another region, a similar group window is displayed. For example, when the first selection operation is performed on the central region 200C, the group window GW2 associated with the rear center row of seats (in other words, the region R3) is displayed (see FIG. 5). When the first selection operation is performed on the left-side region 200L, a group window associated with the left row of rear seats (in other words, area R4) is displayed. When the first selection operation is performed on the right edge region 200F, a group window associated with the passenger seat (in other words, region R1) is displayed.

For example, the group window GW2 displays components 210D and 210G corresponding to the information processing devices 10D and 10G installed in the center row of the rear seats. Component 210D displays column information and a small window 220D. Component 210G displays column information and a small window 220G. The small window 220D displays a mirrored image with the information processing device 10D as the sharing source. The small window 220G displays a mirrored image with the information processing device 10G as the sharing source.

By visually checking the small window 220, parent user A can understand what content the child user seated in the selected region (the right row of rear seats in the example of FIG. 3, and the center row of rear seats in the example of FIG. 5) is watching. In other words, parent user A can know what content the child user is viewing without directly viewing the screen 142 of the information processing device 10 at the other seat.

Parent user A can limit the region in the vehicle interior and display a mirrored image of the information processing device 10 that belongs to the limited area on screen 142A. Therefore, even when a large number of information processing devices 10 are installed in the vehicle interior, the space within the screen 142 required to display the playback status of the content can be kept small (in other words, only the group window). For example, parent user A can know what content the child user is viewing while ensuring the display space for objects C1 and C2.

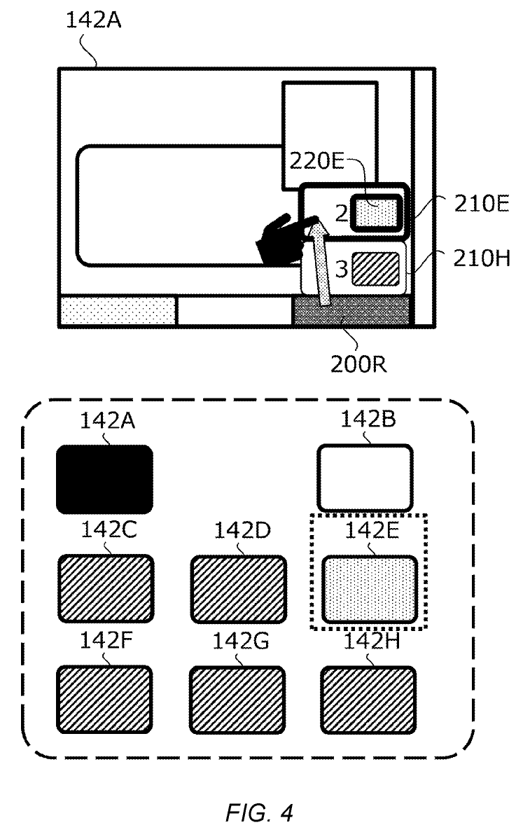

For example, when parent user A performs the first selection operation and then moves his/her finger onto a component 210 in the group window, the component 210 where the finger is moved to is selected. In the example of FIG. 4, the component 210E is in a selected state.

Parent user A can drag and drop the small window 220 of the selected component 210 in the selected state. In the examples of FIG. 4 and FIG. 5, parent user A drags small window 220E into central region 200C. Parent user A performs the first selection operation while dragging small window 220E. As a result, the group window GW2 is displayed on the screen 142A.

In the example of FIG. 5, parent user A drops small window 220E on component 210D of group window GW2. Upon detecting this drop operation, the information processing device 10A instructs the information processing devices 10D and 10E to share the mirrored image displayed in the small window 220E with the information processing device 10D corresponding to the component 210D. As a result, the information processing device 10D and the information processing device 10E communicate, and the display screen of the information processing device 10E is displayed as a mirrored image on the screen 142D of the information processing device 10D.

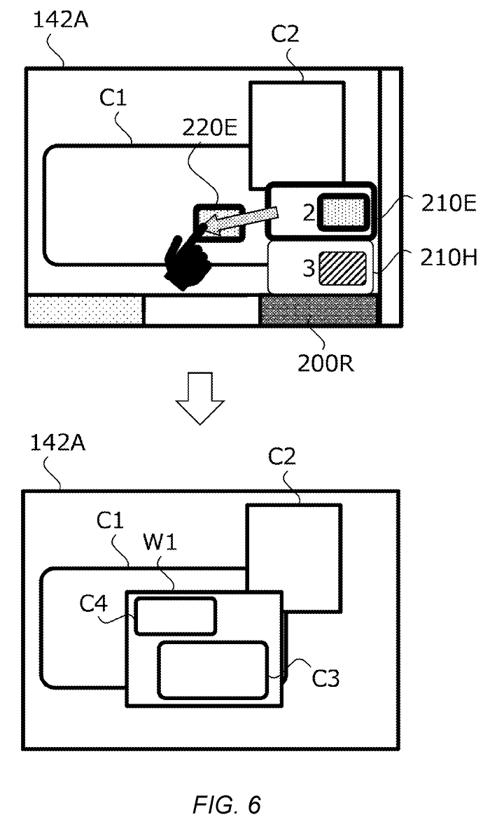

In the example depicted in the upper diagram of FIG. 6, parent user A drags and drops the small window 220E outside group window GW1. As a result, the small window 220E is resized to a prescribed size and arranged at the drop position. As depicted in the lower diagram of FIG. 6, the resized small window 220E is referred to as "window W1". The display screen of the information processing device 10E continues to be displayed in the window W1 in, for example, MIRACAST. For example, a mirrored image in which objects C3 and C4 are arranged in the same layout as on screen 142E is displayed in window W1.

The window W1 is displayed in a size that occupies, for example, one-fourth of the entire screen 142A. For example, if the screen 142A and the screen 142E have the same resolution, the mirrored image of the information processing device 10E, which is the sharing source, is reduced to 50% size and displayed in the window W1. For example, if the screen 142A is 4K (3,840×2,160) and the screen 142E is FHD (1,920×1,080), the mirrored image of the information processing device 10E that is the sharing source is displayed in the window W1 at the same size. That is, the mirrored image is resized based on the screen resolution of the sharing source and the sharing destination and then displayed in the window.

Parent user A can change the display size of window W1 to an arbitrary size by, for example, touching a corner of window W1 with a finger and sliding the corner in an arbitrary direction.

The information processing device 10 supports, for example, a User Input Back Channel (UIBC). The information processing device 10A operating as a sync device transmits an event corresponding to an operation by parent user A on a mirrored image displayed in a window to the information processing device 10 operating as a source device. The information processing device 10 operating as the source device executes control in response to the event.

As an example, when parent user A touches the play button of object C3 displayed in window W1, a corresponding control command is transmitted from information processing device 10A to information processing device 10E. In accordance with the received control command, the information processing device 10E starts playing back the content of the object C3 (for example, video content). In other words, the window W1 also serves as a GUI that accepts operations by the parent user A on the screen 142E of the information processing device 10E installed at a remote location.

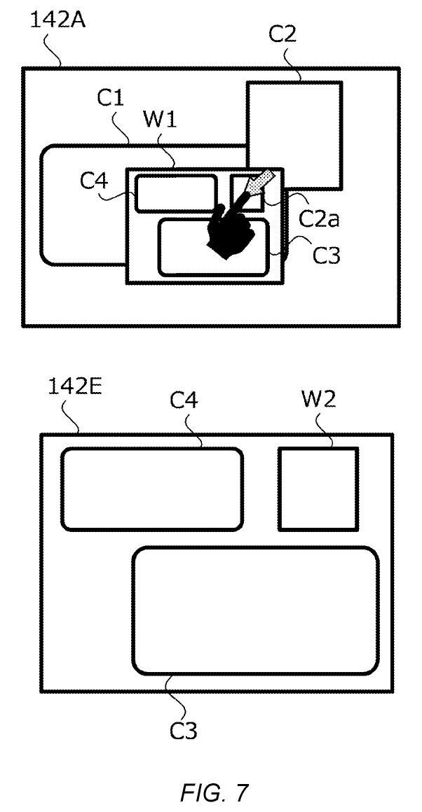

Parent user A can change the layout of objects being displayed in window W1. In the example depicted in the upper diagram of FIG. 7, parent user A touches (in other words, presses and holds) object C2 displayed on screen 142A with their finger for a certain period of time. As a result, a draggable object C2a is generated and displayed on the screen 142A. Object C2a is, for example, a copy of object C2 that has been reduced to a size that is easy to operate (for example, 50% of the size of object C2), and is displayed in front of object C2.

In the example depicted in the upper diagram of FIG. 7, parent user A drags object C2a displayed on screen 142A and drops the object within window W1. As a result, the object C2a is arranged at the drop position. When the object C2a is arranged at the drop position, the object is resized to fit into the available space in the window W1, for example.

The information processing device 10A, operating as a sync device, instructs the information processing device 10E to display the window W2 according to the drag position or drop position of the object C2a in the window W1, and generates a mirrored image of the object C2a and transfers the object to the information processing device 10E. As a result, as depicted in the lower diagram of FIG. 7, objects C3 and C4 and window W2 (more specifically, windowed object C2a) are displayed on screen 142E of information processing device 10E. In other words, a part of the display content of the sync device is transferred to the source device and displayed as a mirrored image.

Thus, according to the present embodiment, an object (for example, object C2a displayed on screen 142A) can be added from the sync device (for example, information processing device 10A) that is the mirroring destination to the screen of the source device (for example, screen 142E of information processing device 10E) that is the mirroring source. The layout of objects displayed on the source device can be changed on the sync device side, improving usability on the sync device side.

Parent user A can, for example, press and hold an arbitrary object in window W1 and drag and drop the object to an arbitrary position within window W1, thereby arbitrarily changing the layout of the objects displayed on screen 142E. Parent user A can erase an object displayed on screen 142E by, for example, long pressing an arbitrary object in window W1 and performing a prescribed erase operation.

In this manner, parent user A can easily perform operations on the screen 142 of the information processing device 10 that is physically out of reach via the information processing device 10A.

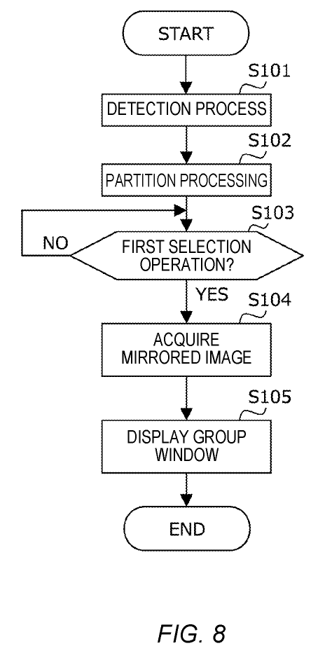

FIG. 8 is a flowchart depicting processing executed by the control unit 100A of the information processing device 10A, which is a sync device, in an embodiment of the present disclosure. For example, when the information processing device 10A is turned ON, the execution depicted in FIG. 8 starts.

The order of the steps in the flowcharts depicted in the present embodiment may be changed as long as there is no inconsistency. In addition, the steps of the flowcharts depicted in the present embodiment may executed concurrently or in parallel as long as there is no contradiction. For example, the present disclosure presents the process of various steps using an example order, but this is not limited to the order presented.

The control unit 100A executes a detection process (step S101). Specifically, the control unit 100A detects an occupant in the interior of a vehicle V1, which is an example of a moving body (in other words, the vehicle interior, which is an example of a prescribed space). The control unit 100A detects the presence or absence of an occupant in each seat using, for example, a DMS (Driver Monitoring System) and a pressure sensor installed in each seat. For example, the control unit 100A regards the information processing device 10 corresponding to the seat in which the occupant is detected as the information processing device 10 in use.

In this manner, the control unit 100A operates as a detection unit that detects the information processing device 10 that is in use from among a plurality of information processing devices 10 (example of source devices) installed in a prescribed space.

The control unit 100A executes partition processing (step S102). Specifically, the control unit 100A partitions the region from within the vehicle cabin based on the installation position of the information processing device 10 currently in use, which is detected in the detection process (step S101). For example, when the information processing device 10 in use is detected in all seats, the control unit 100A divides the interior of the vehicle into four regions R1 to R4, as depicted in FIG. 1. For example, if the information processing device 10 in use is detected only in the second row right seat, the second row left seat, and the third row right seat, the control unit 100A divides the interior of the vehicle into two regions (a region including the second row right seat and the third row right seat, and a region including the second row left seat).

In this manner, the control unit 100A operates as a partitioning part that partitions a partitioned region (for example, regions R1 to R4) from within the vehicle cabin (example of a prescribed space) based on the installation position of the information processing device 10 (example of a source device) in use, which is detected in the detection process (step S101).

The control unit 100A waits for a first selection operation (step S103). When the control unit 100A detects the first selection operation (step S103: YES), it then acquires a mirrored image (step S104). In the example depicted in FIG. 3, the control unit 100A requests the display screen, in other words, the mirrored image, from the information processing devices 10E and 10H associated with the first selection operation that selects a region including the right row of rear seats (example of a partitioned region, for example, region R2). Upon receiving the request, the information processing devices 10E and 10H transfer the mirrored image to the information processing device 10A. As a result, the control unit 100A operating as an acquisition unit acquires mirrored images (example of a shared source image, which is a display image on the second screen) of the information processing devices 10E and 10H (example of a source device).

The control unit 100A displays a group window (step S105). In the example of FIG. 3, the control unit 100A displays a group window GW1 in which a mirrored image of the information processing device 10E is embedded in the small window 220E of the component 210E, and a mirrored image of the information processing device 10H is embedded in the small window 220H of the component 210H.

In this manner, the control unit 100A operates as a display control unit. When the control unit 100A, which operates as a display control unit, detects the first selection operation, the control unit displays, on the screen 142A (example of a first screen), a shared source image (a mirrored image) displayed on the screen 142 (example of a second screen) of each information processing device 10 (example of a source device) installed in the selected partitioned region (for example, the region R2). In addition, the control unit 100A, which operates as a display control unit, displays the mirrored images of each information processing device 10 installed in the partitioned region selected by the first selection operation at a first magnification so that they fit within the small window 220.

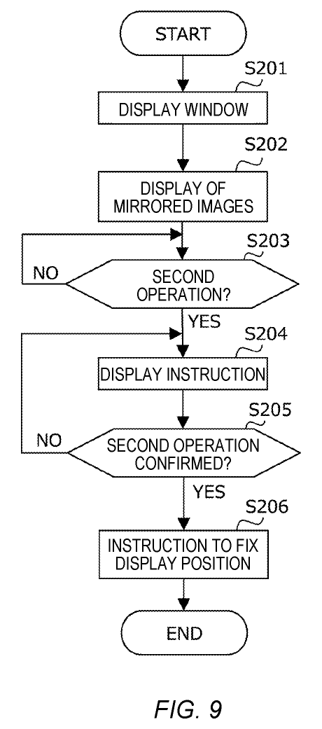

FIG. 9 is a flowchart depicting processing executed by the control unit 100A of the information processing device 10A, which is a sync device, in an embodiment of the present disclosure. For example, when the second selection operation is detected, the execution of the process depicted in FIG. 9 is started.

The second selection operation (prescribed first operation) is an operation of dragging and dropping an arbitrary one of the small windows 220 prescribed in the group window to an arbitrary position outside the group window. In the example of FIG. 6, the second selection operation is an operation of dragging and dropping one small window 220E (in other words, the mirrored image of the information processing device 10E) from among the small windows 220E and 220H (in other words, the mirrored image of the information processing device 10E and the mirrored image of the information processing device 10H) displayed in the group window GW1. In other words, the second selection operation is an operation of selecting one shared source image from among the shared source images displayed on the second screen of each source device installed in the partitioned region selected in the first selection operation.

When the control unit 100A detects a second selection operation (in other words, a prescribed first operation), the control unit displays a window (example of a first window, for example, window W1) on the screen 142A and displays the mirrored image selected by the second selection operation in this window (steps S201 to S202).

Specifically, the control unit 100A, which operates as a display control unit, displays the mirrored image selected by the second selection operation (in other words, the mirrored image in the small window 220 displayed at the first magnification) in the first window (for example, in window W1) at a second magnification that is greater than the first magnification. Additionally, the control unit 100A, which operates as a display control unit, adjusts the display size of the mirrored image (example of a shared source image) based on the resolution of the screen 142A (example of a first screen) and the screen 142 (example of a second screen) of the sharing source information processing device 10 (for example, adjusts the size to occupy one-fourth of the entire screen 142A), and displays the resized mirrored image in the first window (for example, window W1).

The control unit 100A waits for a prescribed second operation (step S203). The second operation is an operation on a first object (for example, object C2a) displayed on screen 142A (example of a first screen). More specifically, the second operation is an operation of dragging the first object into the first window (for example, into window W1).

When the control unit 100A detects the second operation (step S203: YES), the control unit provides instruction to the target source device (step S204). The target source device is the information processing device 10 (for example, information processing device 10E) that is the sharing source of the mirrored image displayed in the first window (for example, window W1) to which the first object (for example, object C2a) is dragged.

In step S204, control unit 100A instructs the source device to display the second window, and also instructs the source device to display the first object in the second window. In the example depicted in the upper diagram of FIG. 7, when object C2a (example of a first object) is dragged into window W1 (example of a first window), control unit 100A instructs information processing device 10E, which is the sharing source of the mirrored image displayed in window W1, to display window W2 (example of a second window) and also instructs the information processing device to display object C2a (example of a first object) in window W2. As a result, the information processing device 10E displays the window W2 displaying the object C2a on the screen 142E (see the lower diagram in FIG. 7).

When parent user A drops object C2a, the second operation is confirmed. In step S205, control unit 100A determines whether or not the second operation has been confirmed. Until the second operation is confirmed, the display position of the window W2 on the screen 142E is successively updated according to the drag position of the object C2a on the screen 142A. In other words, the control unit 100A, which operates as a display control unit, instructs updating of the display position of the window W2 (example of the second window) on the screen 142E (example of the second screen) based on the drag position of the object C2a (example of the first object). In response to this instruction, the information processing device 10E updates the display position of the window W2.

When the second operation is confirmed (step S205: YES), the control unit 100A instructs the source device (for example, the information processing device 10E) to fix the display position of the window W2 at the drop position (step S206). That is, the control unit 100A, which operates as a display control unit, instructs fixing of the display position of the window W2 (example of the second window) on the screen 142E (example of the second screen) based on the drop position of the object C2a (example of the first object). In accordance with this determination, information processing device 10E fixes the display position of window W2.

The description provided thus far is a description of exemplary embodiments of the present disclosure. The embodiments of the present disclosure are not limited to those described above, and various modifications are possible within the scope of the technical concept of the present disclosure. For example, appropriate combinations of embodiments and the like that are explicitly indicated by way of example in the specification or obvious embodiments and the like are also included in the embodiments of the present application.

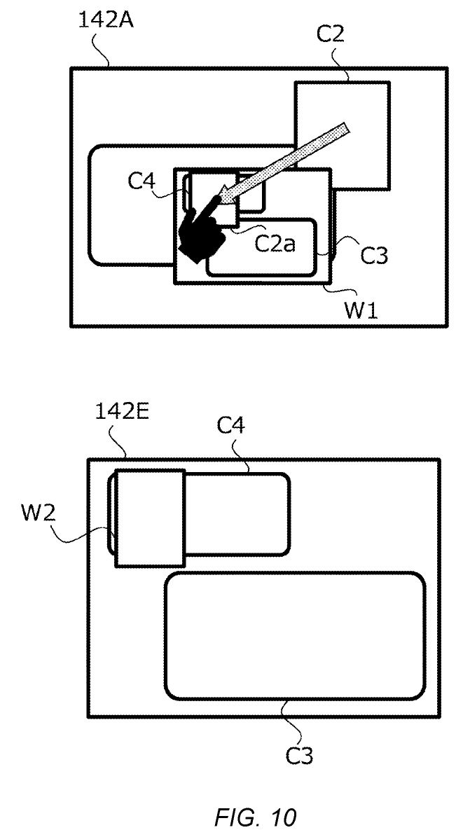

For example, a priority may be set for the object. When the first object is dropped onto the first window, the objects may be arranged in a layout that reflects the priority. The layout of objects in which priority is reflected will be described with reference to FIG. 10.

In the example of FIG. 10, object C3 has a high priority, and object C4 has a low priority. In the example depicted in the top diagram of FIG. 10, parent user A drops object C2a (example of a first object) at a position where overlapping both object C3 and object C4. In this case, the display size of the object C2a is reduced so as to not overlap with the object C3, which has a higher priority, for example. For example, the object C2a is displayed in front of the object C4, which has a lower priority. As depicted in the lower diagram of FIG. 10, the window W2 is also displayed on the screen 142E of the information processing device 10E operating as the source device at a size and position corresponding to the object C2a.

In the example of FIG. 10, even when a first object is added, the visibility of an object with a high priority is ensured. In this manner, when one of a plurality of second objects (for example, objects C3 and C4) displayed in window W1 (example of a first window) overlaps with the drop position of the first object (for example, object C2a), the control unit 100A, which operates as a display control unit, determines the layout of the first object and each second object based on the priority of each second object.

The priority of the object is set in advance by, for example, the provider of the application 110A. The priority of an object may be set in response to a user operation.

In the above embodiment, the inside of a vehicle is used as an example, but the present embodiment can also be applied to cases where a plurality of information processing devices 10 are operating, for example, when working in an office, giving a presentation in a conference room, or playing a game in a living room.

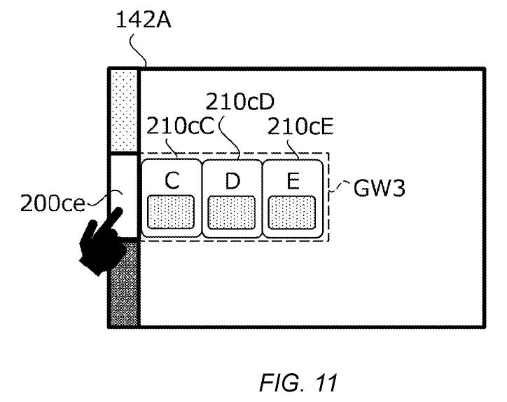

FIG. 11 depicts an example of a front screen of a screen 142A according to Modified Example 1 of the present disclosure. In the above embodiment, the interior of the vehicle is divided into vertical rows (right row, center row, left row), but the partition units are not limited to this. For example, in Modified Example 1, the interior of the vehicle is divided into row units. Specifically, in Modified Example 1, the interior of the vehicle is divided into a first-row region (region including the passenger seat), a second-row region (region including the three seats in the second row), and a third-row region (region including the three seats in the third row).

For example, in Modified Example 1, when parent user A swipes his/her finger horizontally to the right by a prescribed distance in region 200ce on screen 142A corresponding to the second column area, a group window GW3 is displayed on screen 142A. The group window GW3 displays components 210cC to 210cE corresponding to the information processing devices 10C to E installed in each seat in the second row seats. As in the above embodiment, parent user A can know what content the child user is viewing. As in the above embodiment, parent user A can easily perform operations on the screen 142 of the information processing device 10 of a child user who is physically out of reach via the information processing device 10A.

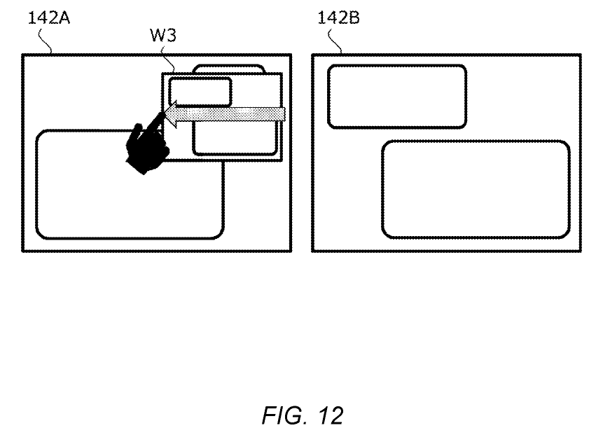

For example, if there is one information processing device 10 installed in a partitioned region, the display of the group window may be omitted. FIG. 12 depicts an example of a display screen of screen 142A and screen 142B according to Modified Example 2 of the present disclosure side by side. In the example of FIG. 12, parent user A swipes their finger horizontally leftward from the right edge of screen 142A (in other words, the end on the passenger seat side) for a prescribed distance.

In the region R1, only the information processing device 10B corresponding to the passenger seat is installed. In this case, window W3 appears as if pulled out horizontally to the left from the right edge of the screen. The window W3 is a window that displays the mirrored image of the information processing device 10B, which is the sharing source. Parent user A can avoid the trouble of selecting the small window 220 from the group window.

The description provided thus far is a description of exemplary embodiments of the present disclosure. The embodiments of the present disclosure are not limited to those described above, and various modifications are possible within the scope of the technical concept of the present disclosure. For example, appropriate combinations of embodiments and the like that are explicitly indicated by way of example in the specification or obvious embodiments and the like are also included in the embodiments of the present application.

### DESCRIPTION OF REFERENCE NUMERALS

1. In-vehicle system

10. Information processing device

100. Control unit

110A. Application

140. Display part

142. Screen

1. An information processing device communicably connected to a source device, the information processing device comprising:
a display part having a first screen;
a display control unit that displays an image on the first screen; and
an acquisition unit that acquires a shared-source image, which is a display image on a second screen of the source device, wherein the display control unit:
when detecting a prescribed first operation, displays a first window and displays the shared source image acquired by the acquisition unit on the first window, and
when detecting a prescribed second operation performed on a first object displayed on the first screen, instructs the source device to display a second window and instructs the source device to display the first object in the second window.

2. The information processing device according to claim 1, wherein the second operation is an operation of dragging the first object into the first window, and the display control part updates a display position of the second window on the second screen based on a drag position of the first object.

3. The information processing device according to claim 2, wherein, when a drop position of the first object overlaps with any of the plurality of second objects displayed in the first window, the display control unit determines layout of the first object and each of the second objects based on priorities of each of the second objects.

4. The information processing device according to claim 1, wherein the display control unit adjusts a display size of the shared source image based on resolutions of the first screen and the second screen, and displays the shared source image after the size adjustment in the first window.

5. An information processing method executed by an information processing device communicably connected to a source device, the method comprising the steps of:
acquiring a shared source image, which is a display image of a second screen of the source device;
displaying a first window on the first screen of the information processing device when detecting a prescribed first operation, and displaying the acquired shared source image in the first window; and
instructing the source device to display a second window when detecting a prescribed second operation performed on a first object displayed on the first screen, and instructing the source device to display the first object in the second window.

6. The information processing method according to claim 5, wherein the second operation is an operation of dragging the first object into the first window, and a display position of the second window on the second screen is updated based on a drag position of the first object.

7. The information processing method according to claim 6, wherein, when a drop position of the first object overlaps with any of the plurality of second objects displayed in the first window, layouts of the first object and each of the second objects are determined based on priorities of each of the second objects.

8. The information processing method according to claim 5, further comprising:
adjusting a display size of the shared source image based on resolutions of the first screen and the second screen, and
displaying the shared source image after the size adjustment in the first window.
